(19) United States
(12) Patent Application Publication
(10) Pub. No.: US 2018/0040419 A1
(43) Pub. Date: Feb. 8, 2018

(54) MULTILAYERED COILS

(71) Applicant: Hamilton Sundstrand Corporation, Charlotte, NC (US)

(72) Inventors: Sameh Dardona, South Windsor, CT (US); Paul Sheedy, Bolton, CT (US)

(21) Appl. No.: 15/231,304

(22) Filed: Aug. 8, 2016

(51) Int. Cl. H01F 41/04; H01F 27/28

(52) U.S. Cl. CPC H01F 41/041; H01F 27/2804; H01F 2027/2809

(57) ABSTRACT

A method of producing electrical coils includes preparing a plurality of coil layers. Each coil layer is prepared by printing an electrically conductive coil pattern on a layer substrate. Each coil pattern includes an inner end at a first via through the substrate at a point radially inside the coil pattern, and an outer end at a second via through the substrate at a point radially outside the coil pattern. The method also includes joining the coil layers into a stack and electrically connecting successive coil patterns of the plurality of coil layers to one another through the vias to form a conductive coil extending through the stack.

### BACKGROUND OF THE INVENTION

### 1. Field of the Invention

The present disclosure relates to electrical components, and more particularly to electromagnetic such as used in inductors, motors, actuators and the like.

### 2. Description of Related Art

Electromagnetic coils are pervasive in electrical and electromechanical (EM) systems. These components are often manufactured using lamination and winding or etching of electrical conductors. The materials in the assembly are traditionally selected for specific properties (e.g.

electrical or thermal conductivity, dielectric strength, or magnetic permeability) and the three dimensional organization of these materials is critical to optimization of device performance.

However, with conventional methods, optimum device designs are theoretical only and are often not manufacturable. Performance is then sacrificed due to processing constraints. One example is the less than 100% copper fill factor in motor winding slots due to physical constraints of the winding process. Another example is the local heating due to low thermal conductivity substrates and insulating polymers. Use of additive manufacturing (AM) methods significantly reduces the manufacturing design constraints for electromagnetic devices. Preliminary explorations of AM for EM devices have yet to find effective methods to fully integrate electrical function with mechanical structure.

Such conventional methods and systems have generally been considered satisfactory for their intended purpose. However, there is still a need in the art for improved electromagnetic coils. The present disclosure provides a solution for this need.

### SUMMARY OF THE INVENTION

A method of producing electrical coils includes preparing a plurality of coil layers. Each coil layer is prepared by printing an electrically conductive coil pattern on a layer substrate. Each coil pattern includes an inner end at a first via through the substrate at a point radially inside the coil pattern, and an outer end at a second via through the substrate at a point radially outside the coil pattern. The method also includes joining the coil layers into a stack and electrically connecting successive coil patterns of the plurality of coil layers to one another through the vias to form a conductive coil extending through the stack.

The layer substrates can include a ceramic material. Each layer substrate can be 20 microns or less in thickness. Printing an electrically conductive coil pattern can include printing the coil pattern on the layer substrate with conductive ink, and thermally heat or laser treating the conductive ink to enhance electrical conductivity in the coil pattern.

For each successive pair of coil layers, the coil patterns can connect to each other by at least one of the first vias of each of the coil layers in the pair or the second vias of each of the coil layers in the pair. Successive pairs of inner vias can be joined at a first inner via location that shifts with each successive pair. Successive pairs of outer vias can be joined at a second via location that shifts with each successive pair. The vias can be respectively filled with conductive ink to establish electrical connections between successive coil patterns.

Every other coil pattern can wind clockwise from the outer end to the inner end thereof, and each remaining coil pattern can wind clockwise from the inner end thereof to the outer end thereof so that there is a common coil winding direction throughout the stack. 80% or more of the volume of the stack can be occupied by the coil patterns.

The coil pattern can be wound in a clockwise direction to produce a downward pointing magnetic field. It is also contemplated that the coil pattern can be wound counter-clock-wise to produce an upward oriented magnetic field.

An electrical coil includes a stack of coil layers. Each coil layer includes a layer substrate with an electrically conductive coil pattern thereon. Each coil pattern includes an inner end at a first via through the substrate at a point inside the coil pattern, and an outer end at a second via through the substrate at a point outside the coil pattern. Each of the coil layers is joined to the stack with successive coil patterns connected to one another through the vias to form a conductive coil extending through the stack. Each of the substrates is identical, e.g., with a plurality of first vias and a plurality of second vias. At least two of the coil patterns can differ from one another. The coil patterns can vary from coil layer to coil layer with respect to at least one of: the inner end of the coil pattern being located at a different one of the first vias of its substrate with each successive pair of coil layers, or the outer end of the coil pattern being located at a different one of the second vias of its substrate with each successive pair of the coil layers.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic perspective view of an exemplary embodiment of an electrical coil constructed in accordance with the present disclosure, showing a stack of electrically connected coil layers;

FIG. 2 is a schematic exploded perspective view of the electrical coil of FIG. 1, showing the coil layers separated; and

FIG. 3 is a schematic plan view of the coil layers of FIG. 2, showing each coil layer prior to stacking.

### DETAILED DESCRIPTION OF THE PREFERRED EMBODIMENTS

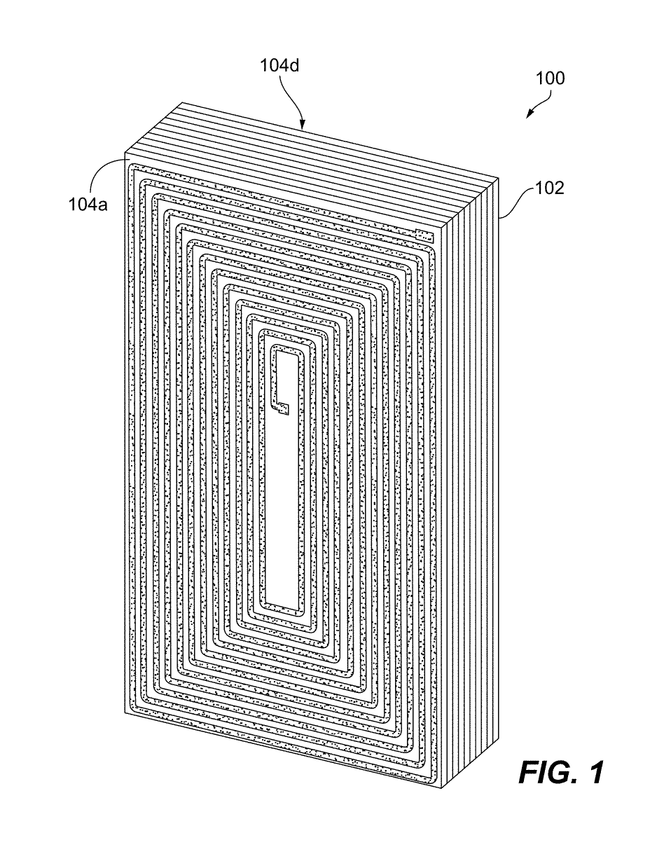

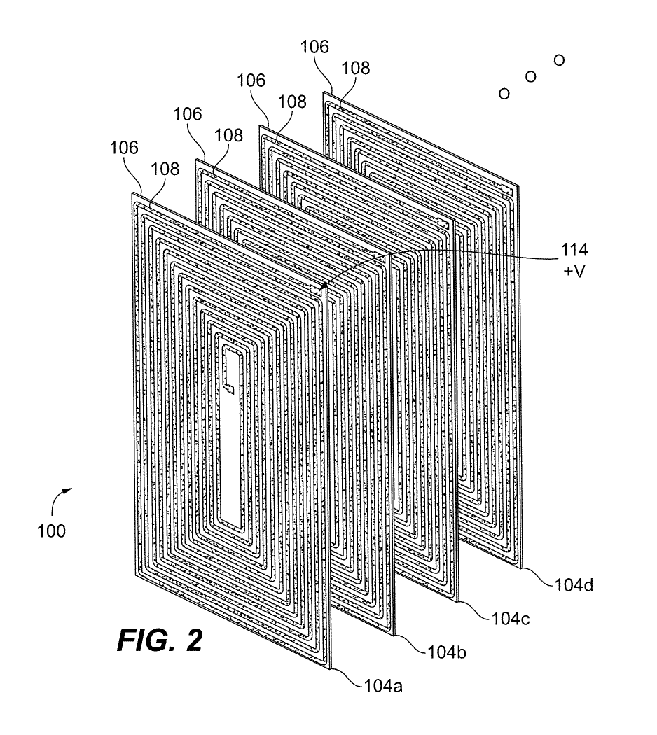

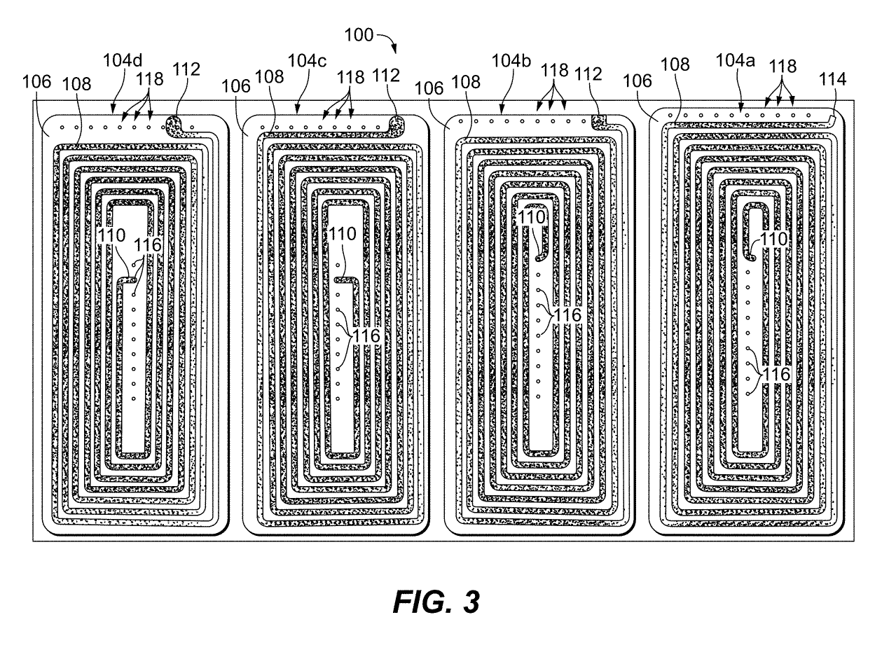

Reference will now be made to the drawings wherein like reference numerals identify similar structural features or aspects of the subject disclosure. For purposes of explanation and illustration, and not limitation, a partial view of an exemplary embodiment of an electrical coil in accordance with the disclosure is shown in FIG. 1 and is designated generally by reference character 100. Other embodiments of electrical coils in accordance with the disclosure, or aspects thereof, are provided in FIGS. 2-3, as will be described. The systems and methods described herein can be used to produce electrical coils for use in electrical and electromechanical systems, such as inductors, motors, actuators, and the like.

An electrical coil 100 includes a stack 102 of coil layers 104a, 104b, 104c, and 104c, which are shown separately in FIG. 2. Those skilled in the art will readily appreciate that while four coil layers are shown and described herein for the sake of clarity, any suitable number of coil layers can be used in a stack without departing from the scope of this disclosure, as indicated by the ellipses in FIG. 2. The more layers are used, the greater the magnetic field strength that can be produced. Each coil layer 104a, 104b, 104c, and 104d includes a respective layer substrate 106 with an electrically conductive coil pattern 108 thereon. As shown in FIG. 3, each coil pattern 108 includes an inner end at a first via 110 through the substrate 106 at a point radially inside the coil pattern 108. Each of coil layers 104b, 104c, and 104d includes an outer end at a second via 112 through the substrate 106 at a point radially outside the coil pattern 108. In the case of coil layer 104a, the outer end of the coil pattern 108 is a voltage take off 114. Each of the coil layers 104a, 104b, 104c, and 104d is joined to the stack 102 as shown in FIG. 1, with successive coil patterns connected to one another through the vias 110 and 112 to form a conductive coil extending through the stack 102.

A method of producing electrical coils, e.g., electrical coil 100, includes preparing a plurality of coil layers, e.g., coil layers 104a, 104b, 104c, and 104d as shown in FIG. 3. Each coil layer is prepared by printing an electrically conductive coil pattern, e.g. coil patterns 108, on a layer substrate, e.g. layer substrate 106. Each coil pattern includes an inner end at a first via, e.g., vias 110, through the substrate at a point inside the coil pattern, and an outer end at a second via, e.g., vias 112, through the substrate at a point outside the coil pattern. The method also includes joining the coil layers into a stack, e.g. stack 102 of FIG. 1, wherein successive coil patterns are connected to one another through the vias to form a conductive coil extending through the stack.

With continued reference to FIG. 3, the layer substrates 106 include a ceramic material. The ceramic material can include magnetic materials to function as a magnetic core in addition to supporting the coil layer. Each layer substrate 106 is 20 microns or less in thickness. Printing an electrically conductive coil pattern includes printing the coil patterns 108 on the layer substrates 106 with conductive ink, e.g. using a direct write process such as ink jet printing, aerosol, extrusion, or spraying powders using thermal plasma (meso-plasma) or micro-cold spray methods, and heat treating the conductive ink to enhance electrical conductivity in the coil patterns 108. Any suitable process can be used, such as thermal curing/sintering at high temperature for stability at operational temperature. The conductive ink can be of any suitable type, e.g., high conductivity metal ink formulations.

For each successive pair of coil layers 108 in the stack 102, the coil patterns 108 connect to each other by at least one of the first vias 110 of each of the coil layers 104a, 104b, 104c, and 104d in the pair. For example, coil layers 104c and 104d connect to each other through their respective vias 110, as do coil layers 104a and 104b. In the alternating parings, the second vias 112 of each of the coil layers 104a, 104b, 104c, and 104d in the pair connect adjacent coil layers 104a, 104b, 104c, and 104d. For example, the pair of coil layers 104b and 104c connect electrically to each other through their respective vias 112. Coil layer 104d could connect to an additional coil layer through its via 112, and so forth. The vias 110 and 112 can all be formed by laser drilling, micro-machining, or any other suitable process, and are respectively filled with conductive ink to establish electrical connections between successive coil patterns 108. This connection ultimately forms a single coil from the take off 114 to the via 112 of coil layer 104d.

With continued reference to FIG. 3, every other coil pattern 104b and 104d winds clockwise from the outer end to the inner end thereof, and each remaining coil pattern 104a and 104c winds clockwise from the inner end thereof to the outer end thereof so that there is a common coil winding direction throughout the stack 102. This arrangement allows for 80% or more of the volume of the stack 102 to be occupied by the coil patterns 104a, 104b, 104c, and 104d.

The coil patterns can be wound in a clockwise direction to produce a downward pointing magnetic field, as oriented in FIG. 3. It is also contemplated that the coil patterns can be wound counter-clock-wise to produce an upward oriented magnetic field, as oriented in FIG. 3.

Additionally, Each of the substrates can be identical, e.g., with a plurality of first vias and a plurality of second vias. At least two of the coil patterns can differ from one another. The coil patterns can vary from coil layer to coil layer with respect to at least one of: the inner end of the coil pattern being located at a different one of the first vias of its substrate with each successive pair of coil layers, or the outer end of the coil pattern being located at a different one of the second vias of its substrate with each successive pair of the coil layers. Successive pairs of inner vias 110 are joined at a first inner via location 116 that shifts, e.g., is in a different location, with each successive pair. For example coil layers 104c and 104d have their inner vias at the second highest via location 116 (as oriented in FIG. 3), whereas coil layers 104a and 104b have their inner vias at the highest via location 116 (as oriented in FIG. 3). This avoids interference or short circuiting between successive pairs of the coil layers. Successive pairs of outer vias 112 are joined at a second via location 118 that shifts, e.g., is different, with each successive pair. For example, coil layers 104b and 104c are joined electrically at the right most via location 118 (as oriented in FIG. 3), and coil layer 104d and the next layer (not pictured), would be joined at the second to the right most via location 118 (as oriented in FIG. 3).

Beyond relaxing design constraints, additive manufacturing, and particularly using flexible and thin substrates with high magnetic permeability, allows for the departure from the traditional wire winding manufacturing and brings the potential for significant cost reduction due to rapid production and a higher level of integration and automation. Those skilled in the art will readily appreciate that while the stack 102 has been shown as a rectangular prism, techniques as described herein can be used to customize a stack of coil layers to fit any suitable envelope shape.

The methods and systems of the present disclosure, as described above and shown in the drawings, provide for electrical coils with superior properties including departure from the limitations of traditional wire windings. For example, greater concentricity can now be obtained than with traditional wire windings. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of producing conductive coils comprising:
preparing a plurality of coil layers, wherein each coil layer is prepared by printing an electrically conductive coil pattern on a layer substrate wherein each coil pattern includes an inner end at a first via through the substrate at a point radially inside the coil pattern, and an outer end at a second via through the substrate at a point radially outside the coil pattern; and
joining the coil layers into a stack; and
electrically connecting successive coil patterns of the plurality of coil layers to one another through the vias to form a conductive coil extending through the stack.

2. A method as recited in claim 1, further comprising connecting each successive pair of coil layers to each other by at least one of the first vias of each of the coil layers in the pair or the second vias of each of the coil layers in the pair.

3. A method as recited in claim 1, wherein printing an electrically conductive coil pattern includes printing the coil pattern on the layer substrate with conductive ink, and further comprising heat treating the conductive ink to enhance electrical conductivity in the coil pattern.

4. A method as recited in claim 1, further comprising filling the vias with conductive ink to establish electrical connections between successive coil patterns.

5. A method as recited in claim 1, further comprising joining successive pairs of inner vias at a first inner via location that is different with each successive pair.

6. A method as recited in claim 1, further comprising joining successive pairs of outer vias at a second via location that is different with each successive pair.

7. A method as recited in claim 1, wherein every other coil pattern winds clockwise from the outer end to the inner end thereof, and wherein each remaining coil pattern winds clockwise from the inner end thereof to the outer end thereof so that there is a common coil winding direction throughout the stack.

8. An electrical coil comprising:
a stack of coil layers, wherein each coil layer includes:
a layer substrate with an electrically conductive coil pattern thereon, wherein each coil pattern includes an inner end at a first via through the substrate at a point inside the coil pattern, and an outer end at a second via through the substrate at a point outside the coil pattern;
wherein each of the coil layers is joined to the stack with successive coil patterns connected to one another through the vias to form a conductive coil extending through the stack.

9. An electrical coil as recited in claim 8, wherein for each successive pair of coil layers, the coil patterns connect to each other by at least one of the first vias of each of the coil layers in the pair or the second vias of each of the coil layers in the pair.

10. An electrical coil as recited in claim 8, wherein each conductive coil pattern includes conductive ink, heat treated for electrical conductivity.

11. An electrical coil as recited in claim 8, wherein the layer substrates include a ceramic material.

12. An electrical coil as recited in claim 8, wherein each layer substrate is 20 microns or less in thickness.

13. An electrical coil as recited in claim 8, wherein 80% or more of the volume of the stack is occupied by the coil patterns.

14. An electrical coil as recited in claim 8, wherein the vias are respectively filled with conductive ink to establish electrical connections between successive coil patterns.

15. An electrical coil as recited in claim 8, wherein successive pairs of inner vias are joined at a first inner via location that is different with each successive pair.

16. An electrical coil as recited in claim 8, wherein successive pairs of outer vias are joined at a second via location that is different with each successive pair.

17. An electrical coil as recited in claim 8, wherein every other coil pattern winds clockwise from the outer end to the inner end thereof, and wherein each remaining coil pattern winds clockwise from the inner end thereof to the outer end thereof so that there is a common coil winding direction throughout the stack.

18. An electrical coil as recited in claim 8, wherein each of the substrates is identical.

19. An electrical coil as recited in claim 8, wherein at least two of the coil patterns differ from one another.

20. An electrical coil comprising:
a stack of coil layers, wherein each coil layer includes:
a layer substrate with an electrically conductive coil pattern thereon, wherein each coil pattern includes an inner end at a first via through the substrate at a point radially inside the coil pattern, and an outer end at a second via through the substrate at a point radially outside the coil pattern;
wherein each of the coil layers is joined to the stack with successive coil patterns connected to one another through the vias to form a conductive coil extending through the stack; and
wherein each layer substrate has a plurality of first vias and a plurality of second vias, wherein each substrate layer is identical, and wherein the coil patterns vary from coil layer to coil layer with respect to at least one of: the inner end of the coil pattern being located at a different one of the first vias of its substrate with each successive pair of coil layers, or the outer end of the coil pattern being located at a different one of the second vias of its substrate with each successive pair of the coil layers.
